(19) United States
(12) Patent Application Publication
(10) Pub. No.: US 2024/0357372 A1
(43) Pub. Date: Oct. 24, 2024

(54) SYSTEMS, APPARATUSES, AND METHODS FOR SHARED SPECTRUM ACCESS BETWEEN PRIMARY AND SECONDARY NETWORKS

(71) Applicant: HUAWEI TECHNOLOGIES CO., LTD., Shenzhen (CN)

(72) Inventors: Liqing ZHANG, Kanata (CA); Hao Tang, Shenzhen (CN); Jianglei Ma, Kanata (CA); Xi Zhang, Kanata (CN)

(21) Appl. No.: 18/758,078

(22) Filed: Jun. 28, 2024

Related U.S. Application Data
(63) Continuation of application No. PCT/CN2021/144046, filed on Dec. 31, 2021.

(51) Int. Cl. H04W 16/14; H04W 72/044

(52) U.S. Cl. CPC H04W 16/14; H04W 72/044

(57) ABSTRACT

In a communication system having a primary wireless communication network and one or more secondary wireless communication network, a primary base station (PBS) of the primary wireless communication network may share a wireless spectrum thereof to one or more secondary base stations (SBSs) of the one or more secondary wireless communication network by dividing the wireless spectrum into a plurality of time-frequency blocks, and sending usage information of at least a portion of the plurality of time-frequency blocks from the PBS to the one or more SBSs for the SBSs to use available time-frequency blocks of the plurality of time-frequency blocks for their communication.

### CROSS-REFERENCE TO RELATED APPLICATIONS

This application is a continuation application of international application No. PCT/CN2021/144046, filed on Dec. 31, 2021, the content of which is incorporated herein by reference in its entirety.

### FIELD OF THE DISCLOSURE

The present disclosure relates generally to systems, apparatuses, and methods for wireless communication, and in particular to systems, apparatuses, and methods for shared spectrum access between primary and secondary networks.

### BACKGROUND

Wireless communication networks are constantly growing to provide a growing number of services. Wireless communication networks are usually operated by operators in large scales and with sufficient amount of licensed spectrum. However, there also exists a need for small-scale wireless communication networks such as those for industrial/automation factory, hospital and healthcare services, and other enterprise or private networks, wherein the operators thereof may not have their own licensed spectrum.

### SUMMARY

Embodiments disclosed herein related to wireless communication systems, apparatuses, and methods for efficiently renting or sharing a communication spectrum such as a licensed spectrum of a large-scale wireless communication networks with one or more other wireless communication systems.

According to one aspect of this disclosure, there is provided a method for sharing a wireless spectrum, the wireless spectrum being divided into a plurality of time-frequency blocks, the method comprising: sending usage information of at least a portion of the plurality of time-frequency blocks from a first node of a first radio access network (RAN) to a second node of a second RAN for the second node of the second RAN to use available time-frequency blocks of the plurality of time-frequency blocks for communication.

In some embodiments, each of the plurality of time-frequency blocks comprises one or more resource block groups (RBGs) over a time period.

In some embodiments, said sending the usage information of the at least portion of the plurality of time-frequency blocks comprises: sending the usage information of the at least portion of the plurality of time-frequency blocks from the first node to the second node using unicasting, group-casting, broadcasting, or a combination thereof.

In some embodiments, said sending the usage information of the at least portion of the plurality of time-frequency blocks comprises: sending from the first node to the second node the usage information of at least one of a first subset and a second subset of the plurality of time-frequency blocks, wherein the usage information of all of the plurality of time-frequency blocks comprises the usage information of the first subset of the plurality of time-frequency blocks and the usage information of the second subset of the plurality of time-frequency blocks.

In some embodiments, said sending the usage information of the at least portion of the plurality of time-frequency blocks comprises: sending from the first node to the second node the usage information of: a first subset of the plurality of time-frequency blocks reclaimably for use by the second node as the available time-frequency blocks.

In some embodiments, said sending the usage information of the at least portion of the plurality of time-frequency blocks further comprises: sending from the first node to the second node the usage information of: a second subset of the plurality of time-frequency blocks releasably for use by a third node.

In some embodiments, said sending the usage information of the at least portion of the plurality of time-frequency blocks comprises: sending from the first node to the second node the usage information of: a first subset of the plurality of time-frequency blocks changed from releasably for use by a third node to reclaimably for use by the second node; and a second subset of the plurality of time-frequency blocks changed from reclaimably for use by the second node to releasably for use by the third node.

In some embodiments, said sending the usage information of the at least portion of the plurality of time-frequency blocks comprises: sending the usage information of all of the plurality of time-frequency blocks from the first node to the second node; the usage information comprises information of at least: a first subset of the plurality of time-frequency blocks reclaimably for use by the second node as the available time-frequency blocks; and a second subset of the plurality of time-frequency blocks releasably for use by a third node.

In some embodiments, the method further comprises: assigning a usage type to each of the plurality of time-frequency blocks for indicating a usage status thereof.

In some embodiments, the usage type comprises any one of: a first usage type indicating that the time-frequency block associated therewith is reclaimably for use by the second node as the available time-frequency blocks; and a second usage type indicating that the time-frequency block associated therewith is releasably for use by a third node.

In some embodiments, the usage type further comprises any one of: a third usage type indicating that the time-frequency block associated therewith is exclusively for use by the second node; and a fourth usage type indicating that the time-frequency block associated therewith is exclusively for use by a third node.

In some embodiments, the third node is the first node.

In some embodiments, the usage information of the at least portion of the plurality of time-frequency blocks comprises: a first grace period for releasing the first subset of the plurality of time-frequency blocks for use by the second node.

In some embodiments, the usage information of the at least portion of the plurality of time-frequency blocks comprises: a second grace period for reclaiming the second subset of the plurality of time-frequency blocks for use by the third node.

In some embodiments, said sending the usage information of the at least portion of the plurality of time-frequency blocks comprises: sending the usage information of the at least portion of the plurality of time-frequency blocks from the first node to the second node via wireless backhauling for transmissions including downlink control information (DCI) signaling and radio resource control (RRC) signaling, wherein the second node is operating as a user equipment (UE) of the first node.

In some embodiments, said sending the usage information of the at least portion of the plurality of time-frequency blocks comprises: sending a first control message from the first node to the second node, the first control message comprising a first indication for indicating the message type of a second control message; and sending the second control message from the first node to the second node, the second control message comprising the usage information of the at least portion of the plurality of time-frequency blocks.

In some embodiments, the first message further comprises a size of the second message.

In some embodiments, the first message further comprises a second indication for indicating whether or not the usage information of the at least portion of the plurality of time-frequency blocks is changed.

In some embodiments, said sending the second message from the first node to the second node comprises: sending the second message from the first node to the second node if the usage information of the at least portion of the plurality of time-frequency blocks is changed.

In some embodiments, said sending the first message from the first node to the second node comprises: sending the first message from the first node to the second node via DCI signaling.

In some embodiments, said sending the second message from the first node to the second node comprises: sending the second message from the first node to the second node via DCI signaling.

In some embodiments, one or more of the plurality of time-frequency blocks releasably for use by the third node comprise one or more resource elements (REs) for use by one or more UEs of the second node for performing channel state information (CSI) estimation.

According to one aspect of this disclosure, there is provided an apparatus of a first radio access network (RAN) for sharing a wireless spectrum, the wireless spectrum being divided into a plurality of time-frequency blocks, the apparatus comprising: a processing unit for: sending usage information of at least a portion of the plurality of time-frequency blocks to a node of a second RAN for the node of the second RAN to use available time-frequency blocks of the plurality of time-frequency blocks for communication.

According to one aspect of this disclosure, there is provided a method for sharing a wireless spectrum, the wireless spectrum being divided into a plurality of time-frequency blocks, the method comprising: receiving, by a second node of a second radio access network (RAN), usage information of at least a portion of the plurality of time-frequency blocks from a first node of a first RAN; and using, by the second node of the second RAN, the usage information for communication using available time-frequency blocks of the plurality of time-frequency blocks.

In some embodiments, each of the plurality of time-frequency blocks comprises one or more resource block groups (RBGs) over a time period.

In some embodiments, said receiving the usage information of the at least portion of the plurality of time-frequency blocks comprises: receiving, by the second node, from the first node the usage information of: a first subset of the plurality of time-frequency blocks reclaimably for use by the second node as the available time-frequency blocks.

In some embodiments, said using the usage information for the communication using the available time-frequency blocks comprises: using, by the second node, the first subset of the plurality of time-frequency blocks for the communication; and stopping using, by the second node, one or more of the plurality of time-frequency blocks not in the first subset for the communication.

In some embodiments, said receiving the usage information of the at least portion of the plurality of time-frequency blocks further comprises: receiving, by the second node, from the first node the usage information of: a second subset of the plurality of time-frequency blocks releasably for use by a third node.

In some embodiments, said using the usage information for the communication using the available time-frequency blocks comprises: using, by the second node, the first subset of the plurality of time-frequency blocks for the communication; and stopping using, by the second node, the second subset of the plurality of time-frequency blocks for the communication.

In some embodiments, said receiving the usage information of the at least portion of the plurality of time-frequency blocks comprises: receiving, by the second node, from the first node the usage information of: a first subset of the plurality of time-frequency blocks changed from releasably for use by a third node to reclaimably for use by the second node; and a second subset of the plurality of time-frequency blocks changed from reclaimably for use by the second node to releasably for use by the third node.

In some embodiments, said using the usage information for the communication using the available time-frequency blocks comprises: updating, by the second node, the available time-frequency blocks using the first subset of the plurality of time-frequency blocks; using, by the second node, the available time-frequency blocks for the communication; and stopping using, by the second node, the second subset of the plurality of time-frequency blocks for the communication.

In some embodiments, said receiving the usage information of the at least portion of the plurality of time-frequency blocks comprises: receiving, by the second node, the usage information of all of the plurality of time-frequency blocks from the first node; the usage information comprises information of at least: a first subset of the plurality of time-frequency blocks reclaimably for use by the second node, and a second subset of the plurality of time-frequency blocks releasably for use by a third node.

In some embodiments, each of the plurality of time-frequency blocks is assigned with a usage type for indicating a usage status thereof.

In some embodiments, the usage type comprises any one of: a first usage type indicating that the time-frequency block associated therewith is reclaimably for use by the second node; and a second usage type indicating that the time-frequency block associated therewith is releasably for use by a third node.

In some embodiments, the usage type further comprises any one of: a third usage type indicating that the time-frequency block associated therewith is exclusively for use by the second node; and a fourth usage type indicating that the time-frequency block associated therewith is exclusively for use by a third node.

In some embodiments, the third node is the first node.

In some embodiments, the usage information of the at least portion of the plurality of time-frequency blocks comprises: a first grace period for releasing the first subset of the plurality of time-frequency blocks for use by the second node.

In some embodiments, the usage information of the at least portion of the plurality of time-frequency blocks comprises: a second grace period for reclaiming the second subset of the plurality of time-frequency blocks for use by the third node.

In some embodiments, said receiving the usage information of the at least portion of the plurality of time-frequency blocks comprises: receiving, by the second node, the usage information of the at least portion of the plurality of time-frequency blocks from the first node via downlink control information (DCI) signaling or via radio resource control (RRC) signaling.

In some embodiments, said receiving the usage information of the at least portion of the plurality of time-frequency blocks comprises: receiving, by the second node, a first message from the first node, the first message comprising a first indication for indicating the message type of a second message; and receiving, by the second node, a second message from the first node, the second message comprising the usage information of the at least portion of the plurality of time-frequency blocks.

In some embodiments, the first message further comprises a size of the second message.

In some embodiments, the first message further comprises a second indication for indicating whether or not the usage information of the at least portion of the plurality of time-frequency blocks is changed.

In some embodiments, said receiving the second message from the first node to the second node comprises: receiving, by the second node, the second message from the first node if the second indication indicates that the usage information of the at least portion of the plurality of time-frequency blocks is changed.

In some embodiments, said receiving the first message from the first node comprises: receiving, by the second node, the first message from the first node via DCI signaling.

In some embodiments, said receiving the second message from the first node comprises: receiving, by the second node, the second message from the first node via DCI signaling.

In some embodiments, one or more of the plurality of time-frequency blocks releasably for use by the third node comprise one or more resource elements (REs) for use by one or more user UEs of the second node for performing channel state information (CSI) estimation.

According to one aspect of this disclosure, there is provided an apparatus of a radio access network (RAN) for sharing a wireless spectrum, the wireless spectrum being divided into a plurality of time-frequency blocks, the apparatus comprising: a processing unit for: receiving usage information of at least a portion of the plurality of time-frequency blocks from a first node of a first RAN; and using the usage information for communication using available time-frequency blocks of the plurality of time-frequency blocks.

Thus, the present disclosure discloses a spectrum-sharing method for use by a primary wireless communication network and the base stations thereof (denoted “primary base station” or “PBS” hereinafter) to share a communication spectrum with a secondary wireless communication network and the base stations thereof (denoted “secondary base station” or “SBS” hereinafter). The spectrum-sharing method disclosed herein and the wireless communication systems and apparatuses thereof provide several advantage over for example, the conventional spectrum-sensing based methods.

As those skilled in the art understand, the conventional spectrum-sensing based methods such as those used in IEEE 802.22 or WI-FI are not very reliable and may lead to higher collision between signals of the PBS and the SBS. Moreover, due to the fact that the spectrum usage in the PBS is generally dynamic over time, the time period from the time of detection of vacant channels or time-frequency blocks in in the PBS using spectrum-sensing to the time of the SBS scheduling traffic to the user equipments (UEs) thereof may often be too long such that the detected vacant channels or time-frequency blocks of the PBS may not be vacant any more.

By using the spectrum-sharing methods disclosed herein, the PBS 112A may notify the SBS 112B the spectrum occupancy information in a timely manner over wireless backhauling via PBS access link for adapting to the dynamic nature of spectrum occupancy and sharing the spectrum in a fast and reliable manner.

### BRIEF DESCRIPTION OF THE DRAWINGS

FIG. 1 is a simplified schematic diagram showing a communication system according to some embodiments of this disclosure, wherein the communication system comprises a primary wireless communication network and a secondary wireless communication network sharing communication resources therebetween;

FIG. 2 is a simplified schematic diagram showing the structure of the primary or second wireless communication network shown in FIG. 1;

FIG. 3 is a simplified schematic diagram of a base station of the primary or second wireless communication network shown in FIG. 1;

FIG. 4 is a simplified schematic diagram of a user equipment (UE) of the primary or second wireless communication network shown in FIG. 1;

FIG. 5 is a simplified schematic diagram showing the spectrum of a prior-art base station divided into a plurality of time-frequency elements;

FIG. 6 is a simplified schematic diagram showing the spectrum of a primary base station (PBS) of the primary wireless communication network shown in FIG. 1 divided into a plurality of time-frequency blocks;

FIG. 7 is a flowchart showing a PBS-side spectrum-sharing procedure performed by the PBS in operation for sharing the spectrum thereof with a secondary base station (SBS) of the secondary wireless communication network shown in FIG. 1, according to some embodiments of this disclosure;

FIG. 8 is a flowchart showing the spectrum occupancy configuration used by the PBS to send a spectrum-sharing notification to the SBS;

FIG. 9 is a flowchart showing a SBS-side spectrum-sharing procedure performed by the SBS for using the available time-frequency blocks shared by the PBS, according to some embodiments of this disclosure;

FIG. 10 shows an example of secondary UEs (SUEs) of the secondary wireless communication network shown in FIG. 1 updating their time-frequency block usage statuses and their bandwidth parts (BWPs) upon receiving the spectrum occupancy and usage information from the SBS;

FIG. 11 shows an example of configuring resource elements (REs) in one or more time-frequency blocks used by the PBS for use by one or more SUEs to perform channel state information (CSI) estimation;

FIG. 12 is a schematic diagram showing an example of the PBS-side and SBS-side spectrum-sharing procedures with respect to a time-frequency block;

FIG. 13 is a schematic diagram showing another example of the PBS-side and SBS-side spectrum-sharing procedures with respect to a time-frequency block;

FIG. 14 is a schematic diagram showing yet another example of the PBS-side and SBS-side spectrum-sharing procedures with respect to a time-frequency block;

FIG. 15 is a schematic diagram showing still another example of the PBS-side and SBS-side spectrum-sharing procedures with respect to a time-frequency block;

FIG. 16 is a flowchart showing a two-stage DCI signaling procedure executed by the PBS for sending simplified spectrum occupancy and usage information to the SBS, according to some other embodiments of this disclosure; and

FIG. 17 is a flowchart showing a spectrum-sharing procedure performed by the PBS, the SBS, and the SUEs, according to some embodiments of this disclosure.

### DETAILED DESCRIPTION

### A. System Structure

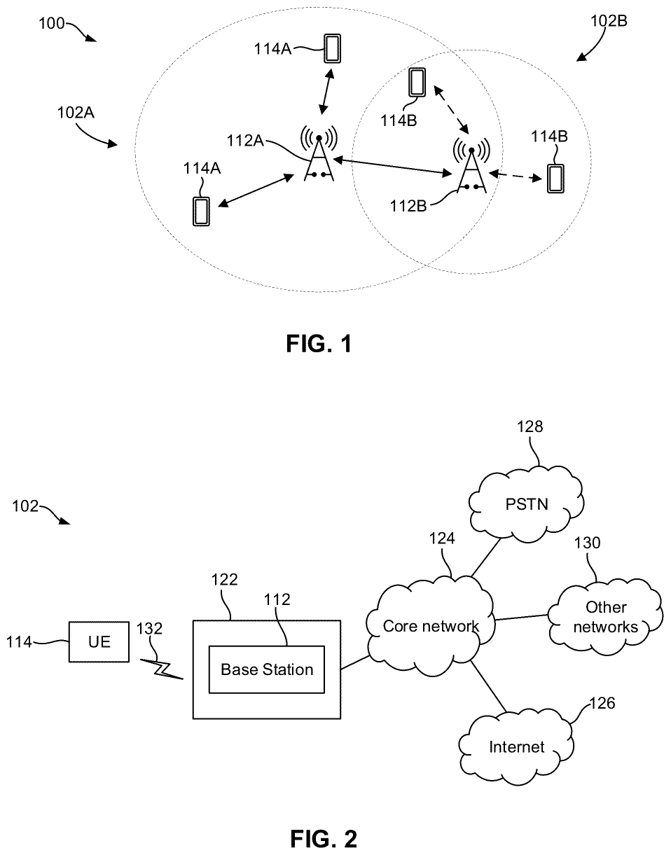

FIG. 1 shows a communication system 100 according to some embodiments of this disclosure. The communication system 100 comprises a primary wireless communication network 102A and a secondary wireless communication network 102B. The primary wireless communication network 102A comprises one or more base stations 112A (also denoted “primary base stations” or “PBS” hereinafter) for servicing a plurality of user equipments (UEs) 114A (also denoted “primary UEs” or “PUEs” hereinafter) connected thereto. The secondary wireless communication network 102B also comprises a base station 112B (also denoted “secondary base station” or “SBS” hereinafter) for servicing a plurality of UEs 114B (also denoted “secondary UEs” or “SUEs” hereinafter) connected thereto.

In the following, the primary and secondary wireless communication networks 102A and 102B are sometimes collectively identified using reference numeral 102, and the plurality of UEs 114A and the plurality of UEs 114B are sometimes collectively identified as 114. However, those skilled in the art will appreciate that the primary and secondary wireless communication networks 102A and 102B are separate wireless communication networks operated independent to each other (except for sharing the spectrum therebetween as described in more detail below), and each UE 114 is a separate device independent to other UEs in terms of channel, traffic, mobility and transmission scheduling, signal generation, and/or the like (except for using shared spectrum for communication as described in more detail below). Any of primary or secondary wireless communication networks 102A and 102B may include infixed base station/network such as terrestrial network or mobile base station/wireless network such as Non-terrestrial network, IAB (Integrated Access and Backhaul) node.

Both wireless communication networks 102A and 102B enable a plurality of wireless or wired UEs 114 to communicate data and other content, and may provide content (such as voice, data, video, text, and/or the like) via broadcast, multicast, unicast, UE-to-UE, and/or the like. The wireless communication networks 102A and 102B may operate efficiently by sharing communication resources such as time and/or frequency resources therebetween.

Those skilled in the art will appreciate that that a “primary” wireless communication network such as 102A and a “secondary” wireless communication network such as 102B are in the sense that the “primary” network may has a higher access priority to access the spectrum and manage the usage of shared spectrum over multiple networks, while the “secondary” network is to share the spectrum usage with other networks such as the “primary” network and other “secondary” networks. Alternatively, the “primary” network may be a prime as a control node to manage the usage of shared spectrum over multiple networks, while its spectrum access priority is same as that of the “secondary” network.

In the secondary wireless communication network 102B, the SBS 112B may be a fixed base station deployed within the coverage area (or “cell”) of the PBS 112A. Alternatively, the SBS 112B may be a mobile base station at least temporarily deployed within one or more cells of the PBS 112A. The SBS 112B is wirelessly connected to the PBS 112A for sharing the frequency resources thereof and using the shared frequency resources for serving the SUEs 114B thereof. Of course, the secondary wireless communication network 102B may also comprise one or more other base stations outside the coverage area of the PBS 112A and in communication with the SUEs 114B for servicing SUEs 114B connected thereto using its own communication resources.

In these embodiments, the primary and secondary wireless communication networks 102A and 102B have a similar structure. As shown in FIG. 2, the wireless communication network 102 (which may be 102A or 102B) comprises one or more radio access networks (RANs) 122 connecting to a core network 124 directly or indirectly (for example, via the internet 126). The core network 124 may be in communication with one or more communication networks such as the internet 126, a public switched telephone network (PSTN) 128, and/or other networks 130. Moreover, the core network 124 of 102A may be different to the core network 124 of 102B.

Internet 126 may include a network of computers and subnets (intranets) or both, and incorporate protocols, such as Internet Protocol (IP), Transmission Control Protocol (TCP), User Datagram Protocol (UDP), and/or the like. PSTN 128 may include circuit switched telephone networks for providing plain old telephone service (POTS).

The RANs 122 are mainly for interfacing or communicating with the UEs 114 to enable the UEs 114 to operate and/or communicate in the wireless communication network 102, or more specifically, to communicate with the core network 124, the internet 126, the PSTN 128, other networks 130, or any combination thereof. The RANs 122 and/or the core network 124 may be in direct or indirect communication with one or more other RANs (not shown), which may or may not be directly served by the core network 124, and may or may not employ the same radio access technology. The core network 124 may also serve as a gateway access between (i) the RANs 122 or UEs 114 or both, and (ii) other networks (such as the internet 126, the PSTN 128, and the other networks 130).

Each RAN 122 comprises one or more base stations or RAN nodes 112 and is configured to wirelessly interface with one or more UEs 114 to enable access to any other base stations 112, the core network 124, the internet 126, the PSTN 128, and/or the other networks 130. A base station 112 may comprise or may be a device in any suitable form such as a base transceiver station (BTS), a Node-B (NodeB), an evolved NodeB (eNodeB), a Home eNodeB, a gNodeB or gNB (next generation NodeB, sometimes called a “gigabit” NodeB), a transmission point (TP), a transmit/receive point (TRP), a site controller, an access point (AP), a wireless router, or the like.

The base station 112 forms part of the RAN 122, which may include other base stations, base station controllers (BSCs), radio network controllers (RNCs), relay nodes, elements, and/or devices. A base station 112 may be a single element, as shown in FIG. 2, or comprise a plurality of elements distributed in the corresponding RAN 122. Each base station 112 transmits and/or receives wireless signals within a particular geographic region or area (that is, a cell or a coverage area). A cell may be further divided into cell sectors, and a base station 112 may for example, employ a plurality of transmitters, receivers, and/or transceivers to provide service to multiple sectors. In some embodiments, there may be established pico or femto cells where the radio access technology supports such. In some embodiments, a plurality of transceivers may be used for each cell for example using multiple-input multiple-output (MIMO) technology. The number of RANs 122 shown in FIG. 2 is exemplary only. Any number of RANs may be contemplated when devising the wireless communication network 102.

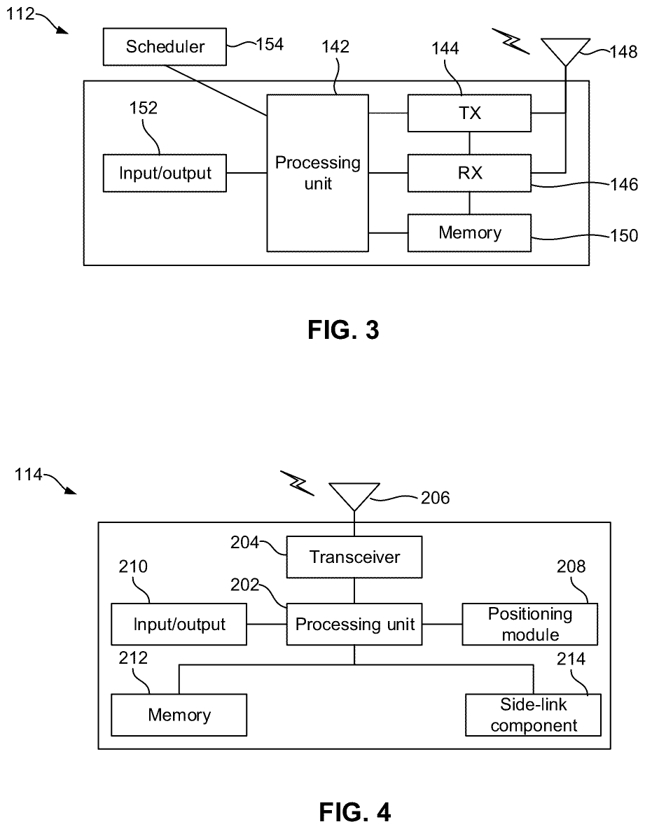

FIG. 3 is a simplified schematic diagram of a base station 112. As shown, the base station 112 comprises at least one processing unit 142, at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the base station 112.

The processing unit 142 is configured for performing various processing operations such as signal coding, data processing, power control, input/output processing, or any other suitable functionalities. The processing unit 142 may comprise a microprocessor, a microcontroller, a digital signal processor, a field-programmable gate array (FPGA), an application-specific integrated circuit (ASIC), and/or the like.

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 3 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the base station 112 described herein.

Each input/output component 152 enables interaction with a user or other devices in the wireless communication network 102. Each input/output device 152 may comprise any suitable structure for providing information to or receiving information from a user and may be for example, a speaker, a microphone, a keypad, a keyboard, a display, a touch screen, a network communication interface, and/or the like.

Referring back to FIG. 2, the base stations 112 of the RANs 122 may communicate with the UEs 114 over an air interface 132 (also denoted “Uu interface”) using any suitable wireless communication links such as radio frequency (RF), microwave, infrared (IR), and/or the like. The air interfaces 132 may utilize any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The air interfaces 132 may use any suitable radio access technologies such as universal mobile telecommunication system (UMTS), high speed packet access (HSPA), HSPA+ (optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (5G NR), standard or non-standard satellite internet access technologies, and/or the like. Herein, a communication from a RAN 122 or a base station 112 thereof to a UE 114 is denoted as a downlink (DL) and a communication from a UE 114 to a RAN 122 or a base station 112 thereof is denoted as an uplink (UL). Accordingly, a channel of the air interface 132 used for a downlink is a DL channel and a channel of the air interface 132 for an uplink is a UL channel.

Herein, the UEs 114 may be any suitable wireless device that may join the wireless communication network 102 via a RAN 122 for wireless operation. In various embodiments, a UE 114 may be a wireless device used by a human or user (such as a smartphone, a cellphone, a personal digital assistant (PDA), a laptop, a computer, a tablet, a smart watch, a consumer electronics device, and/or the like). A UE 114 may alternatively be a wireless sensor, an Internet-of-things (IoT) device, a robot, a shopping cart, a vehicle, a smart TV, a smart appliance, a wireless transmit/receive unit (WTRU), a mobile station, a fixed or mobile subscriber unit, a machine type communication (MTC) device, or the like. Depending on the implementation, the UE 114 may be movable autonomously or under the direct or remote control of a human, or may be positioned at a fixed position.

In some embodiments, the UEs 114 may be multimode devices capable of operation according to multiple radio access technologies and incorporate multiple transceivers necessary to support such.

In addition, some or all of the UEs 114 comprise functionality for communicating with different wireless devices and/or wireless networks over different wireless links using different wireless technologies and/or protocols. Instead of wireless communication (or in addition thereto), the UEs 114 may communicate via wired communication channels to other devices or switches (not shown), and to the Internet 126.

FIG. 4 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, at least one memory 212, and at least one side-link component 214.

The processing unit 202 is configured for performing various processing operations such as signal coding, data processing, power control, input/output processing, or any other functionalities to enable the UE 114 to join the wireless communication network 102 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like.

The at least one transceiver 204 may be configured for modulating data or other content for transmission by the at least one antenna 206 to communicate with a RAN 122. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the UE 114. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the UE 114.

The one or more input/output components 210 is configured for interaction with a user or other devices in wireless communication network 102. Each input/output component 210 may comprise any suitable structure for providing information to or receiving information from a user and may be for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one side-link component 214 is configured for communicating with other devices such as other UE devices 114 via suitable wired or wireless interfaces which may be the air interface 132 for communication between the UE 114 and the RAN 122, or may be other wired or wireless interfaces such as USB cable, network cable, parallel cable, serial cable, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), and/or the like.

### B. Shared Spectrum Access Between Primary and Secondary Networks

As those skilled in the art understand, a base station generally uses a predefined radio frequency range (also called “spectrum” or “channel bandwidth” hereinafter) for wireless communication with the UEs thereof.

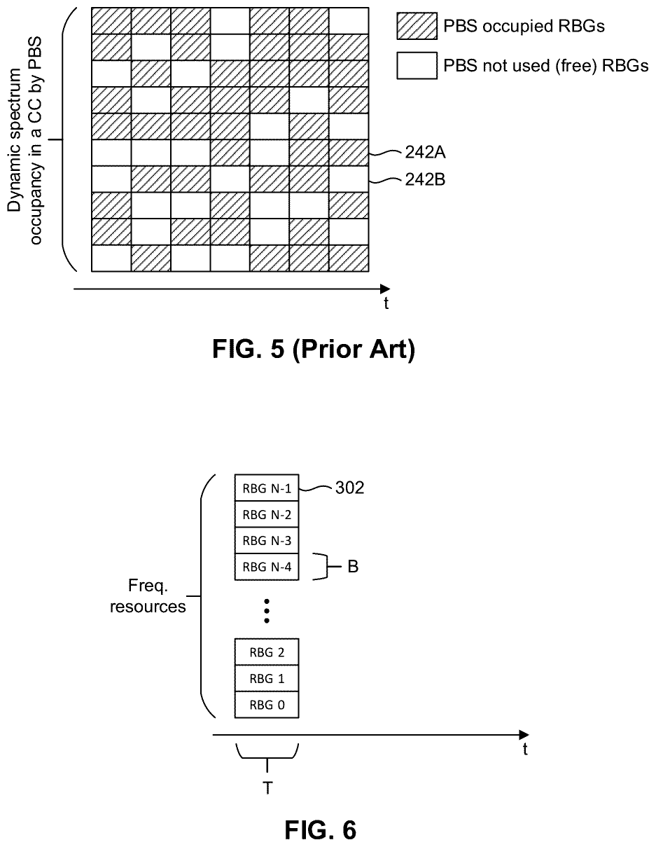

In general, the spectrum of a base station (such as a component carrier (CC) thereof) is usually divided into a plurality of frequency resource elements (REs), one or more REs construct one resource block (RB), and one or more RBs constructs one RBG. As shown in FIG. 5, in prior art, a plurality of resource block groups (RBGs) 242 (with each RBG having a predefined bandwidth) over a time period (for example, 7 millisecond (ms)). As can be seen from the example shown in FIG. 5, while many RBGs 242A are occupied by the base station for communication with the UEs thereof over time intervals (each being, for example, 1 ms), there may exist unused RBGs 242B in each of these time intervals. For example, during a traffic scenario during a time of period 7 ms as shown in FIG. 5, the spectrum occupancy (also called “spectrum usage” hereinafter) may be about 60% of the RBGs 242A, and there exist about 40% unused RBGs 242B.

As a result, the time-frequency elements of a PBS 112A of the primary wireless communication network 102A in the communication system 100 may be shared with the SBS 112B of the secondary wireless communication network 102B for communication with the SUEs 114B thereof.

However, in prior art, for a PBS 112A to share the unused spectrum such as 242B with other networks such as a SBS 112B, the PBS 112A may need to estimate its own traffic loading (and channel conditions) and other relevant measurements to determine its spectrum demand in a relatively long period of time for example, 10 ms or longer, such that the expected unused spectrum can be shared with the other networks by the PBS 112A notifying these spectrum occupancy usage information to the other networks such as the SBS 112B (in a semi-static way), as well as with more exchanging information between them on the spectrum occupancy and usage changes or updates for possible more dynamically shared spectrum usage (in a dynamic way).

In the following, shared spectrum access between the primary and secondary wireless communication networks 102A and 102B is described using an exemplary communication system 100 in some embodiments wherein the communication system 100 and the PBS 112A, PUES 114A, SBS 112B, and SUEs 114B thereof operate according to standardized wireless communication technologies such as LTE, 5G NR, and/or the like, and with the spectrum-sharing methods disclosed herein. Those skilled in the art will appreciate that the shared spectrum access methods disclosed herein may also be used in other communication systems having primary and secondary wireless communication networks 102A and 102B.

In the communication system 100, one functionality of the SBS 112B is to act as a device or equipment similar to a PUE 114A in the primary wireless communication network 102A, performing information exchanging (wirelessly or via a fixed wire connection) with the PBS 112A. The SBS 112B (acting as a device in the primary wireless communication network 102A once communicating with PBS 112A on spectrum usage information exchanges) may be pre-assigned or configured with an identifier (ID) by the PBS 112A. The ID of the SBS 112B may be a predefined sequence or a sequence generated by the PBS 112A using a predefined method. Alternatively, the ID of the SBS 112B may be configured by the PBS 112A for example, via radio resource control (RRC) signaling during the SBS initial access to the PBS 112A.

According to one aspect of this disclosure, the PBS 112A may share the unused time-frequency resources (for example, the spectrum unused by the PBS 112A) with the SBS 112B by sending spectrum-sharing notifications to the SBS 112B notifying the spectrum portions available thereto. The PBS 112A may send such notifications periodically and/or as needed. As will be described in more detail later, in various embodiments, the PBS 112A may send a spectrum-sharing notification to the SBS 112B by for example, a semi-static configuration such as a RRC message to configure the entire or a large portion of the shared spectrum for a time period T (which usually involves a relatively large amount of data to be transmitted from the PBS 112A to the SBS 112B). Alternatively or in addition, the PBS 112A may send an update message as the spectrum-sharing notification to the SBS 112B by for example, a dynamic indication (such as physical-layer (Layer 1) signaling (or “L1 signaling”)) on information of a portion of the shared spectrum, such as a Message R and/or a Message C for a dynamic spectrum usage change (which usually involves a small amount of data to be transmitted from the PBS 112A to the SBS 112B) within the time period T (T may be in unit of symbols/sub-frames or may be a predefined or configured time period such as one (1) ms, five (5) ms, 10 ms, 20 ms, or the like).

Herein, a Message R is based on a first list of RBG blocks over the time period T (denoted “RBG-T blocks” hereinafter) that are RRC configured for use by a node of the primary wireless communication network 102A (such as the PBS 112A), where one or more of RBG-T blocks from the first list may be released for use by a node of the secondary wireless communication network 102B (such as the SBS 112B) (for a releasing time period or for the time period T).

A Message C is based on a second list of RBG-T blocks that are RRC configured by the node of the primary wireless communication network 102A for use by the node of the secondary wireless communication network 102B, where one or more of RBG-T blocks from the second list may be claimed back (or reclaimed) and used by the node of the primary wireless communication network 102A (for a releasing time period or for the time period T).

The Message R and/or Message C may be carried as part of control information in a DCI signaling, for example, a second-stage DCI message. As an example, the second-stage DCI messages to carry Message R and/or Message C size may have different DCI payload sizes, which may be indicated by for example, a first-stage DCI signaling.

The shared spectrum may be defined and configured in terms of frequency bands and/or channel bandwidth in a frequency band, where the channel bandwidth in the frequency band may include usable frequency resource blocks (RBs) or resource block groups (RBGs), where one RB/RBG (for example, the lowest RB/RBG) from the usable frequency RBs or RBGs may be used as a reference RB/RBG for the other RBs or RBGs. A reference RB or RBG may also be configured in terms of for example, being associated with an absolute frequency point. As a result, the spectrum occupation indication in a channel bandwidth of one frequency band may be denoted by RB or RBG indices, where one or more RBs/RBGs may be used to define or configure bandwidth part which is a sub-band (or a subset) of the channel bandwidth. As one RBG comprises one or more RBs and the size of the RBG may be configurable, RBGs and their indices are used to describe the spectrum/frequency blocks and the shared spectrum occupancy usage. With these exemplary settings, FIG. 6 shows the spectrum of a PBS 112A of the primary wireless communication network 102A divided into a plurality of time-frequency blocks. As shown, for the spectrum-sharing purpose, the PBS 112A may divide the time and spectrum resources into a plurality of N time-frequency blocks 302 (N>1 is an integer) for use by the PBS 112A (for example, for communication with PUEs 114A of the primary wireless communication network 102A and/or other purposes under the management of the PBS 112A) and for spectrum sharing with the SBS 112B (for communication with SUEs 114A of the secondary wireless communication network 102B and/or other purposes under the management of the SBS 112B). Each time-frequency block 302, for example, as a semi-static configuration, has a predefined bandwidth B (depending on the number of RBs included and numerology configured), and a predefined time period T (for example, 10 ms, or an integer multiple of frame/slot duration). Herein, the frequency bandwidth B is considered the smallest frequency-domain granularity for spectrum-information exchange between the primary and secondary networks and the bandwidth B may comprise one or more RBGs.

While in various embodiments, the bandwidth B and time period T of each time-frequency block 302 may be configured as different values, and different time-frequency blocks 302 may have different bandwidths B and time periods T (for example, the bandwidth B may be pre-defined or pre-configured for different RBGs), in these embodiments, the bandwidth B may be integer multiples of the bandwidth of the standardized frequency-domain resource granularities such as RBGs with subcarrier spacing of an integer multiple of 15 kHz for example, and the time period T may be an integer multiple of standardized time interval such as 1 ms or 10 ms. Thus, the time-frequency block 302 are also denoted “RBG-T blocks” or “RBG-T resource blocks” hereinafter.

For ease of description, all N RBG-T blocks 302 in these embodiments have a same time period T. However, those skilled in the art will appreciate that the shared spectrum access methods disclosed herein are readily applicable in other embodiments wherein different RBG-T blocks 302 may have different time periods T.

The PBS 112A associates each RBG-T 302 with one of a plurality of usage types or usage indications for tracking and monitoring the shared spectrum occupancy and usage. For example, in these embodiments, four (4) usage types are defined including:
exclusively for use by the PBS 112A (denoted “usage type I” hereinafter);
releasably for use by the PBS 112A (that is, currently for use by the PBS 112A and releasable for use by the SBS 112B; denoted “usage type II” hereinafter);
reclaimably for use by the SBS 112B (that is, currently for use by the SBS 112B and reclaimable for use by the PBS 112A; denoted “usage type III” hereinafter); and
exclusively for use by the SBS 112B (denoted “usage type IV” hereinafter).

In other words, RBG-T blocks 302 of usage type II are currently for use by the PBS 112A and may be released for use by the SBS 112B at a later time, at which time the PBS 112A may notify (for example, by sending a Message R) to a SBS 112B for use (for an time interval, or a releasing duration).

RBG-T blocks 302 of usage type III are for use by the SBS 112B and may be reclaimed by a notification sent from the PBS 112A (for example, a Message C) to the SBS 112B such that the RBG-T block may be reclaimed from the SBS 112B for use by the PBS 112A (and the PUEs 114A thereof) at a later time (for an time interval, or a reclaiming duration).

Therefore, usage types II and III are generally considered changeable usage types or indications and may be updated in a dynamic way within the period of T. Among these two usage types, the PBS 112A may schedule RBG-T blocks 302 of usage type II for PUEs 114A to use, and the SBS 112B may schedule RBG-T blocks 302 of usage type III for SUEs 114B to use.

On the other hand, RBG-T blocks 302 of usage types I and IV are reserved and dedicated for use by the PBS 112A and SBS 112B, respectively, and therefore are generally considered unchangeable usage types or indications at least within the period of T herein, and the use of the RBG-T blocks 302 of usage types I and IV will only be briefly described in the following description. However, those skilled in the art will appreciate that the RBG-T blocks 302 of usage types I and IV may be changed to any of the four usage types (such as usage types II or III) as need after for example, the current period of T.

Each of the four usage types may be represented by a two-bit code for example:
usage type I: 00;
usage type II: 01;
usage type III: 10; and
usage type IV: 11.

Table 1 shows an example of the usage types of all RBG-T blocks 302.

TABLE 1
SHARED SPECTRUM RESOURCE DIVISION AND USAGES

| RBG-T | Assigned | |
|---|---|---|
| block | usage | |
| index | type code | Notes |
| 0 | 00 | Usage type I: exclusively used by the PBS 112A |
| 1 | 01 | Usage type II: releasably for use by the PBS 112A |
| 2 | 01 | Usage type II: releasably for use by the PBS 112A |
| 3 | 10 | Usage type III: reclaimably for use by the SBS 112B |
| . . . | . . . | . . . |
| N-4 | 10 | Usage type III: reclaimably for use by the SBS 112B |
| N-3 | 01 | Usage type II: releasably for use by the PBS 112A |
| N-2 | 11 | Usage type IV: exclusively used by the SBS 112B |
| N-1 | 10 | Usage type III: reclaimably for use by the SBS 112B |

By using the above-described spectrum division and usage types, the PBS 112A forms a spectrum-sharing notification having the spectrum occupancy and usage information of all RBG-T blocks 302 (that is, a full list of the usage types of all RBG-T blocks 302) and sends to the SBS 112B this spectrum-sharing notification at the beginning of each time period T in a semi-static configuration via RRC signaling.

The spectrum occupancy and usage information of all RBG-T blocks 302 may give rise to a large payload (for example, using one bit to indicate one RBG for pre-defined or pre-configured RBG resources with an ordering index, and one or more bits to describe the resource block usage types for one or more RBGs). Note that the RBG-T blocks of usage types I and IV are reserved and their usage types are generally unchanged for example, within a time period T, the information thereof does not need to be sent to the SBS 112B in spectrum-sharing notifications for example, within the time period T.

Therefore, in some embodiments, the PBS 112A also forms a reclaimable-block list and a releasable-block list. The reclaimable-block list comprises information (for example, the usage types) of all RBG-T blocks of usage type III (currently for use by a SBS, some of which may be reclaimed later by the PBS). The indices of these RBG-T blocks are re-indexed (for example, from 0 to N′−1, wherein N′ is the total number of RBG-T blocks of usage type III in Table 1), and the correspondence between the indices of RBG-T blocks in the reclaimable-block list and the indices of the same RBG-T blocks in the full list is maintained by the PBS 112A.

Similarly, the releasable-block list comprising information (for example, the usage types) of all RBG-T blocks of usage type II (currently for use by the PBS, some of which can be released for use by a SBS). The indices of these RBG-T blocks are re-indexed (for example, from 0 to N″−1, wherein N′ is the total number of RBG-T blocks of usage type II in Table 1), and the correspondence between the indices of RBG-T blocks in the releasable-block list and the indices of the same RBG-T blocks in the full list is maintained by the PBS 112A.

For example, the reclaimable-block and releasable-block lists corresponding to Table 1 are shown below.

TABLE 2
RECLAIMABLE-BLOCK LIST

| RBG-T | Assigned | |
|---|---|---|
| block | usage | |
| re-index | type code | Notes |
| 0 | 10 | Corresponding to RBG-T block 3 in Table 1 |
| . . . | . . . | . . . |
| N′-2 | 10 | Corresponding to RBG-T block N-4 in Table 1 |
| N′-1 | 10 | Corresponding to RBG-T block N-1 in Table 1 |

where N′ is the total number of RBG-T blocks of usage type III in Table 1. The size of the information with respect to the reclaimable RBG-T blocks is determined based on the RBG-T blocks of usage type III in the reclaimable-block list.

TABLE 3
RELEASABLE-BLOCK LIST

| RBG-T | Assigned | |
|---|---|---|
| block | usage | |
| re-index | type code | Assigned usage type |
| 0 | 01 | Corresponding to RBG-T block 1 in Table 1 |
| 1 | 01 | Corresponding to RBG-T block 2 in Table 1 |
| . . . | . . . | . . . |
| N″-1 | 01 | Corresponding to RBG-T block N-3 in Table 1 |

where N″ is the total number of RBG-T blocks of usage type II in Table 1. The size of the information with respect to the releasable RBG-T blocks is determined based on the RBG-T blocks of usage type II in the releasable-block list.

During the time period T, the PBS 112A may update the shared spectrum by releasing and/or reclaiming some RBG-T blocks, correspondingly update the reclaimable-block and releasable-block lists, and send one or both of the two lists to the SBS 112B via L1 or DCI signaling. By excluding the RBG-T blocks of usage types I and IV, the payloads of the spectrum-sharing notifications in a DCI or L1 signaling may be reduced.

As will be described in more detail below, during the time period T, the RBG-T blocks referred in the reclaimable-block and releasable-block lists are unchanged while their usage types may be dynamically changed by the PBS 112A for adjusting the spectrum sharing. At the beginning of each time period T, the PBS 112A may the usage types of all RBG-T blocks 302 to the SBS 112B and re-form the reclaimable-block and releasable-block lists. In other words, the RBG-T blocks referred in the reclaimable-block and releasable-block lists may change at the beginning of time period T depending on the spectrum-sharing status.

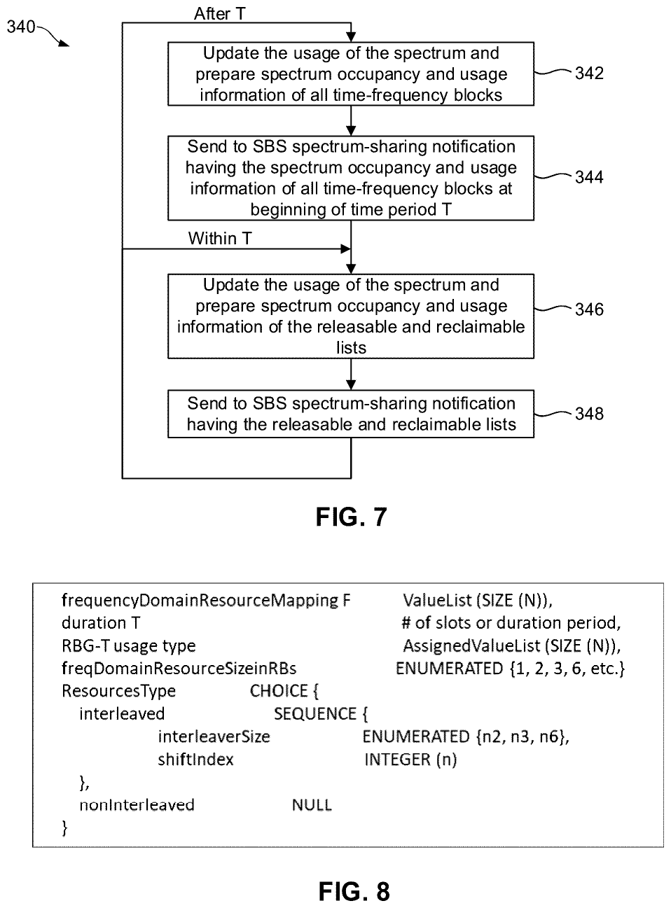

FIG. 7 shows a PBS-side spectrum-sharing procedure 340 performed by the PBS 112A for sharing the spectrum thereof with the SBS 112B.

As described above, the PBS 112A may adjust the usage of RBG-T blocks 302 from time to time for example, releasing some RBG-T blocks 302 when the PBS 112A expects its traffic load will reduce, or reclaiming some RBG-T blocks 302 that are currently allocated to one or more SBSs 112B when the PBS 112A expects its traffic load will increase. At the beginning of a time period T, the PBS 112A updates the usage types of the RBG-T blocks 302 based on the spectrum-sharing status and prepares the spectrum occupancy and usage information having a full list of usage types of all RBG-T blocks 302 of the spectrum (that is, all RBG-T blocks 302 in a channel bandwidth of one frequency band; for example, a full list of those shown in the column “Assigned usage type code” of Table 1) and other parameters such as interleaving or non-interleaving on spectrum using a configuration as shown in FIG. 8 (step 342). The full list of usage types of all RBG-T blocks 302 may be an ordered list such that the orders of the RBG-T blocks in the list implicitly indicate the indices thereof.

At step 344, the PBS 112A sends to the SBS 112B a spectrum-sharing notification having the spectrum occupancy and usage information via RRC signaling.

Steps 342 and 344 are performed by the PBS 112A at the beginning of the time-period T. As described above, the PBS 112A also forms the reclaimable-block and releasable-block lists. The SBS 112B then uses the received spectrum-sharing notification to adjust its spectrum usage (described in more detail later).

Within the time period T, the PBS 112A may adjust the usage of RBG-T blocks 302 and updates the reclaimable-block and/or releasable-block lists as needed (step 346). Then, the PBS 112A forms a spectrum-sharing notification comprising the reclaimable-block and/or releasable-block lists (depending on which list is updated) and other related parameters, and sends the spectrum-sharing notification to the SBS via DCI signaling. The SBS 112B then uses the received spectrum-sharing notification to adjust its spectrum usage.

The procedure 340 then loops to step 346 when the time is still within the time period T (thus RBG-T block releasing or RBG-T block reclaiming may happen more than once within the current time period T), or loops to step 342 when the time period T is over.

In the procedure 340, the notifications may be scheduled or pre-configured by the PBS-side spectrum and using a signaling procedure similar to a PUE in the PBS.

Those skilled in the art will appreciate that, while both the reclaimable-block and releasable-block lists may be sent from the PBS 112 to the SBS 112B within the time period T at step 348, there may be more likely that the reclaimable-block and releasable-block lists may be updated at different times, and that at a time instant within a time period T, the PBS 112 only needs to send to the SBS 112B either the reclaimable-block list or the releasable-block list at step 348.

The SBS 112B maintains a copy of the fill list, the reclaimable-block list, and the releasable-block list. The SBS 112B monitors the spectrum-sharing notifications (or indications) from the PBS 112A via DCI signaling carried over a control channel such as Physical downlink control channel (PDCCH) in time-frequency resources, where the time-frequency resources are similar to NR CORESET that defines search spaces and PDCCH candidates, and the time-frequency resources may be predefined such as fixed symbol and resource blocks (RBs) in sub-frame or RRC configured by the PBS 112A. By decoding a DCI message, the DCI message may schedule a Physical downlink shared channel (PDSCH) transmission that includes one notification (which is RRC signaling and configuration from the PBS 112A).

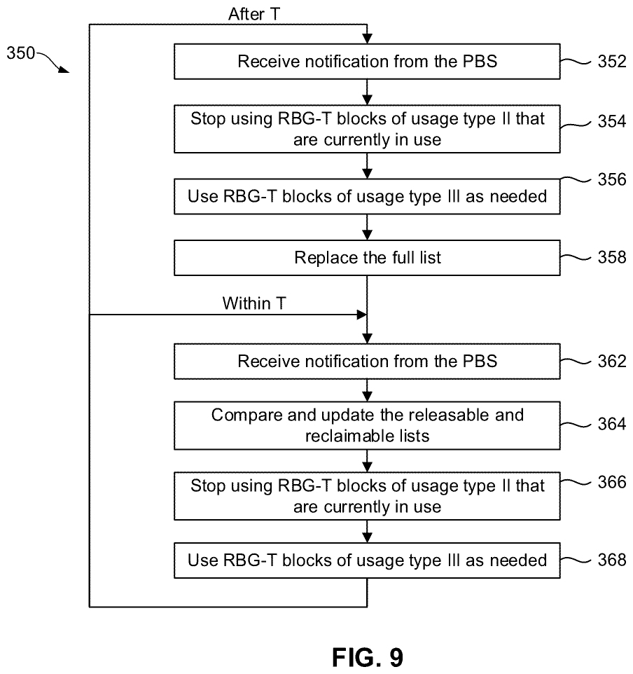

FIG. 9 shows a SBS-side spectrum-sharing procedure 350 performed by the SBS 112B for adjusting its spectrum usage.

At the beginning of the time period T, the SBS 112B receives the spectrum-sharing notification having the above-described full list from the PBS 112A via RRC signaling (step 352). The SBS 112B may acknowledge or have a hand-shaking procedure with the PBS to confirm (ACK) if the spectrum-sharing notification is correctly received; or NACK to the PBS if the spectrum-sharing notification is not correctly received, where retransmission(s) of the spectrum-sharing notification may be required based on predefined or configured procedure.

The SBS 112B then compares the received full list and the full list it maintains to identified the RBG-blocks with changed usage types (for example, some RBG-T blocks may change from type usage II to usage type III thereby becoming available, and some others may change from usage type III to type usage II thereby becoming unavailable). At step 354, the SBS 112B notifies one or more UEs to stop using the unavailable RBG-T blocks of usage type II that are indicated in the received full list but are currently in use by the SBS 112B. For example, the SBS 112B may broadcast, group-cast, or unicast the associated unavailable RBG-T blocks 302 of usage type II to the SUEs 114B. The SUEs 114B then update their available RBGs and stop using these RBG-T blocks as informed by the SBS 112B in order to allow the PBS 112A to reclaim these part of the shared spectrum for use (for a reclaiming duration). As a result, their associated bandwidth parts (BWPs) that consist of one or more of these unavailable RBGs (within the unavailable RBG-T blocks) may need to be updated accordingly to form new BWPs, which will be used in DCI scheduling as references for resource allocation.

At step 356, the SBS 112B may use the RBG-T blocks of usage types III and IV in the received full list for communication with the SUEs 114B. For example, when a SUE 114B requests a RBG-T block for communication, the SBS 112B may assigned the available RBGs within RBG-T block of usage types III and/or IV to the SUE 114B. The SUE 114B may send feedback to the SBS 112B which may be an ACK to confirm the RBG assignment or a NACK for indicating failure of receiving the RBG assignment. Of course, in some other embodiments, the SUE 114B may not send any feedback to the SBS 112B. The SBS 112B may update its usage information on its Type III RBG-T blocks (that is, used by which SUEs), and both SBS 112B and SUEs 114B may update their configured BWPs accordingly.

At step 358, the SBS 112 replaces the full list it maintains with the received full list.

At time instant ta during the time period T, the SBS 112B receives a spectrum-sharing notification with spectrum occupancy and usage information having the above-described releasable-block and/or reclaimable-block lists from the PBS 112A via DCI signaling (step 362). The SBS 112B may acknowledge or have a hand-shaking procedure with the PBS to confirm (ACK) if the spectrum-sharing notification is correctly received; or NACK to the PBS if the spectrum-sharing notification is not correctly received, where retransmission(s) of the spectrum-sharing notification may be required based on predefined or configured procedure.

The SBS 112B then compares the releasable-block and/or reclaimable-block lists with the releasable-block and/or reclaimable-block lists it maintains to identified the RBG-blocks with changed usage types (for example, some RBG-T blocks may change from type usage II to usage type III thereby becoming available, and some others may change from usage type III to type usage II thereby becoming unavailable).

At step 364, the SBS 112B notifies one or more UEs to stop using the unavailable RBG-T blocks of usage type II that are indicated in the received full list but are currently in use by the SBS 112B. For example, the SBS 112B may broadcast, group-cast, or unicast the associated unavailable RBG-T blocks 302 of usage type II to the SUEs 114B. The SUEs 114B then update their available RBGs and stop using these RBG-T blocks as informed by the SBS 112B in order to allow the PBS 112A to reclaim these part of the shared spectrum for use (for a reclaiming duration). As a result, their associated bandwidth parts (BWPs) that consist of one or more of these unavailable RBGs (within the unavailable RBG-T blocks) may need to be updated accordingly to form new BWPs, which will be used in DCI scheduling as references for resource allocation.

At step 366, the SBS 112B may use the RBG-T blocks of usage types III and IV in the received full list for communication with the SUEs 114B. For example, when a SUE 114B requests a RBG-T block for communication, the SBS 112B may assigned the available RBGs within RBG-T block of usage types III and/or IV to the SUE 114B. The SUE 114B may send feedback to the SBS 112B which may be an ACK to confirm the RBG assignment or a NACK for indicating failure of receiving the RBG assignment. Of course, in some other embodiments, the SUE 114B may not send any feedback to the SBS 112B. The SBS 112B may update its usage information on its Type III RBG-T blocks (that is, used by which SUEs), and both SBS 112B and SUEs 114B may update their configured BWPs accordingly.

At step 368, the SBS 112 replaces the releasable-block and/or reclaimable-block lists it maintains with the received releasable-block and/or reclaimable-block lists.

The procedure 350 then loops to step 362 when the time is still within the time period T (thus RBG-T block releasing or RBG-T block reclaiming may happen more than once within the current time period T), or loops to step 352 when the time period T is over.

FIG. 10 shows an example of SUEs updating their RBG usage statuses and their BWPs upon receiving the spectrum occupancy and usage information from the SBS 112B. As shown, the SUE1 is using some RBGs as indicated by its BWP1 and the SUE2 will use some RBGs as indicated by its BWP2 at one time instant/slot. At a later time instant/slot for example, at step 354 or 364, the SBS 112B broadcasts to SUE1 and SUE2 that the RBG 372 becomes unavailable (that is, reclaimed back by the PBS 112A). In response, the SUE1 stops it use of RBGs 372 and adjusts its BWP1 to BWP1′. The SUE2 also stops its planned use of RBGs 372 and adjusts its BWP2 to BWP2′. The SUEs 114B may not perform measurements on the unavailable RBGs after updating its BWP(s) for example, for energy saving.

In some embodiments, the SBS 112B may update the spectrum occupancy and usage information individually to each impacted SUE (that is, each SUE that may be impacted by the spectrum occupancy and usage information) via for example, RRC signaling or L1 signaling; or the SBS 112B may update or re-configure the BWP(s) individually to each impacted SUE via for example, RRC signaling or L1 signaling.

In some embodiments, a SUE 114B may go through a hand-shaking procedure with the SBS 112B upon receiving its RRC signaling on spectrum usage and after updating its BWP(s) such that both the SUE 114B and the SBS 112B have the same knowledge of the available (or unavailable) RBG-T blocks before the next spectrum-sharing notification is sent from the PBS 112A.

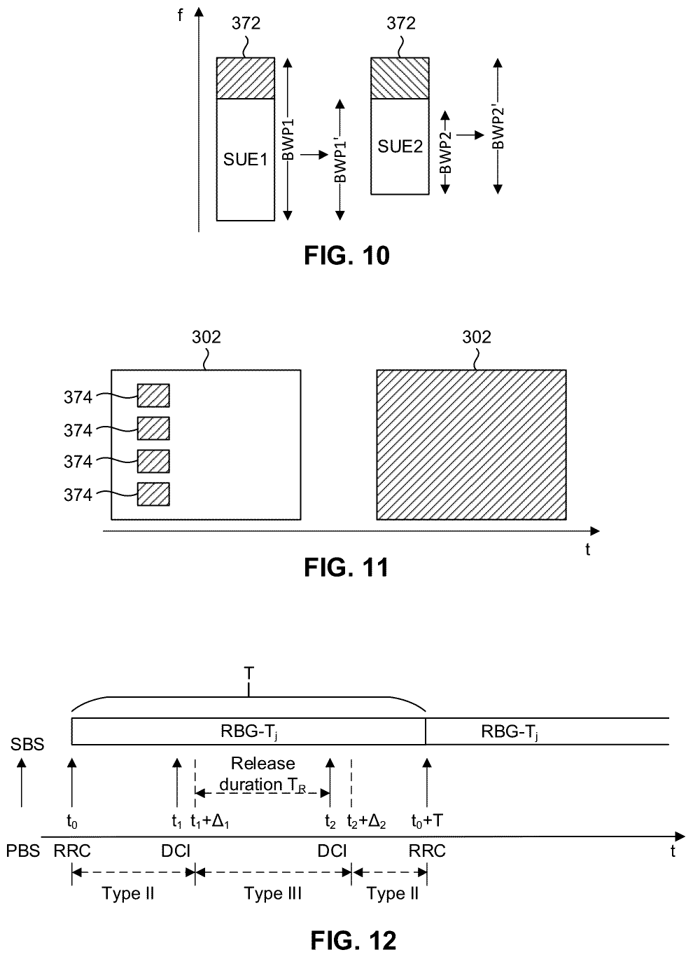

In some embodiments as shown in FIG. 11, one or more RBG-T blocks 302 of type II may be configured such that some resource elements (REs) 374 thereof may be used by one or more SUEs 114B to perform channel state information (CSI) estimation so as to be ready for immediate usage of these RBG-T blocks 302 of type II once the PBS 112A releases them.

In some embodiments, the SBS 112B may send a request to the PBS 112A for more spectrum usage or for an expected spectrum demand (such as estimated by the SBS 112B based on for example, aggregated traffic in the SBS 112B) to the PBS 112A to help the PBS 112A more efficiently manage the spectrum sharing or shared spectrum access. The SBS 112B may send the request by using signaling similar to buffer status request (BSR) or scheduling request (SR) in a manner similar to a PUE 114A sending a request to the PBS 112A. However, the PBS 112A does not schedule time and frequency resources for traffic communication for the SBS 112B. Rather, the PBS 112A sends spectrum-sharing notifications on available or all spectrum to the SBS 112B as described above.

FIG. 12 is a schematic diagram showing an example of the execution of the PBS-side and SBS-side spectrum-sharing procedures 340 and 350 with respect to the j-th RBG-T block RBG-Tⱼ. In this example, the PBS 112A may send a comprehensive spectrum-sharing notification having the above-described full list (which may have a large payload) at the beginning of each time period T or on demand via RRC, and may send one or more intermediate or dynamic spectrum-sharing notifications each having the releasable-block and/or reclaimable-block lists within the time period T via DCI with the benefits of the reduced payload.

As shown in FIG. 12, the PBS 112A sends to the SBS 112B a comprehensive spectrum-sharing notification comprising the above-described full list at time to (which is the starting time of a time period T) via RRC, wherein RBG-Tⱼ is assigned with usage type II (meaning that it is used by the PBS 112A and may be released to the SBS 112B).

At time t₁ within the time period T, the PBS 112A sends to the SBS 112B via DCI an intermediate spectrum-sharing notification having a releasable-block list.

According to the releasable-block list, RBG-Tⱼ is released to the SBS 112B at the t₁ as the usage type of RBG-Tⱼ is changed from Type II to Type III in the releasable-block list. However, in order to prevent collision or misalignment between PBS 112A and SBS 112B in using the shared spectrum, a first grace period Δ₁ is introduced to allow the PBS 112A to stop using RBG-Tⱼ before the SBS 112B actually uses it. In other words, the SBS 112B cannot use RBG-Tⱼ until time t₁+Δ₁.

The releasable-block list comprises a release duration T_{R} associated with RBG-Tⱼ, meaning that the SBS 112B may use RBG-Tⱼ from time t₁+Δ₁ for a time duration T_{R} to t₂=t₁+Δ₁+T_{R}, and the released RBG-Tⱼ is valid for use by the SBS 112B only for a period of (Δ₁+T_{R}) and by default, the RBG-Tⱼ is then automatically “return” to the PBS 112A after t₂ in order to reduce the signaling. Furthermore, the SBS 112B may receive another notification from the PBS 112A to decide whether or not the SBS 112B shall stop using RBG-Tⱼ.

In this example, the PBS 112A sends another intermediate spectrum-sharing notification to the SBS 112B via DCI at time t₂ having the updated releasable-block list, in which RBG-Tⱼ is associated with usage type II indicating that it is reclaimed back to the PBS 112A. However, in order to prevent collision or misalignment between PBS 112A and SBS 112B in using the shared spectrum, a second grace period Δ₂ is introduced to allow the SBS 112B to stop using RBG-Tⱼ before the PBS 112A actually uses it. In other words, the PBS 112A will not use RBG-Tⱼ until time t₂+Δ₂.

The PBS 112A may send to the SBS 112B another comprehensive spectrum-sharing notification at t₀+T or based on demand via RRC as needed.

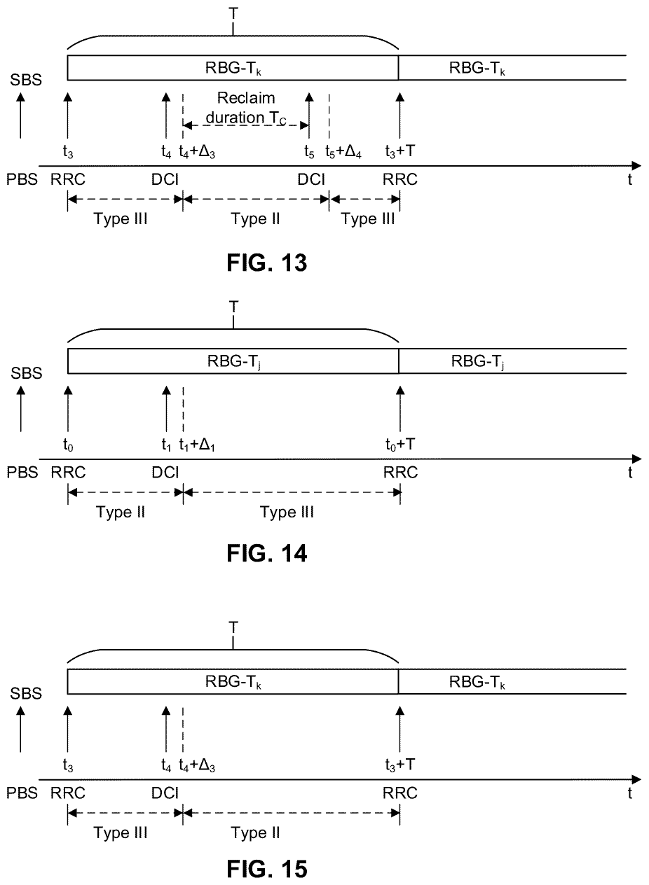

FIG. 13 is a schematic diagram showing another example of the execution of the PBS-side and SBS-side spectrum-sharing procedures 340 and 350 with respect to the k-th RBG-T block RBG-Tₖ.

As shown in FIG. 13, the PBS 112A sends to the SBS 112B a comprehensive spectrum-sharing notification comprising the above-described full list at time t₃ (which is the starting time of a time period T) via RRC, wherein RBG-Tₖ is assigned with usage type III (meaning that it is used by the SBS 112B and may be reclaimed back to the PBS 112A).

At time t₄ within the time period T, the PBS 112A sends to the SBS 112B via DCI an intermediate spectrum-sharing notification having a reclaimable-block list.

According to the reclaimable-block list, RBG-Tₖ is reclaimed back to the PBS 112A at the t₄ as the usage type of RBG-Tₖ is changed from Type III to Type II in the reclaimable-block list. However, in order to prevent collision or misalignment between PBS 112A and SBS 112B in using the shared spectrum, a grace period 43 is introduced to allow the SBS 112B to stop using RBG-Tₖ before the PBS 112A actually uses it. In other words, the PBS 112A cannot use RBG-Tₖ until time t₄+Δ₃.

The reclaimable-block list comprises a reclaim duration T_{C} associated with RBG-Tₖ, meaning that the PBS 112A may use RBG-Tₖ from time t₄₊₄₃ for a time duration T_{C} to t₅=t₄+Δ₃+T_{C}, and the released RBG-Tₖ is valid for use by the PBS 112A only for a period of (43+T_{C}) and by default, the RBG-Tₖ is then automatically “return” to the SBS 112B after t₅ in order to reduce the signaling.

In this example, the PBS 112A sends another intermediate spectrum-sharing notification to the SBS 112B via DCI at time t₅ having the updated reclaimable-block list, in which RBG-Tₖ is associated with usage type III indicating that it is released to the SBS 112B. However, in order to prevent collision or misalignment between PBS 112A and SBS 112B in using the shared spectrum, a grace period 44 is introduced to allow the PBS 112A to stop using RBG-Tₖ before the SBS 112B actually uses it. In other words, the SBS 112B cannot use RBG-Tₖ until time t₅+Δ₄.

The PBS 112A may send to the SBS 112B another comprehensive spectrum-sharing notification at t₃+T or based on demand via RRC as needed.

FIG. 14 is a schematic diagram showing yet another example of the execution of the PBS-side and SBS-side spectrum-sharing procedures 340 and 350 with respect to the j-th RBG-T block RBG-Tⱼ. This example is similar to that shown in FIG. 12 except that, in this example, the intermediate spectrum-sharing notification sent to the SBS 112B at time t₁ does not specify a release duration, which means that RBG-Tⱼ would not be automatically reclaimed back to the PBS 112A and the SBS 112B may continue to use RBG-Tⱼ until the end of the time period T or when the SBS 112B receives another intermediate spectrum-sharing notification that reclaimed RBG-Tⱼ back to the PBS 112A.

FIG. 15 is a schematic diagram showing still another example of the execution of the PBS-side and SBS-side spectrum-sharing procedures 340 and 350 with respect to the k-th RBG-T block RBG-Tₖ. This example is similar to that shown in FIG. 13 except that, in this example, the intermediate spectrum-sharing notification sent to the SBS 112B at time t₄ does not specify a reclaim duration, which means that RBG-Tₖ would not be automatically released to the SBS 112B and the PBS 112A may continue to use RBG-Tₖ until the end of the time period T or when the PBS 112A sends another intermediate spectrum-sharing notification that releases RBG-Tₖ to the SBS 112B.

In some embodiments, the grace periods Δ₁ and Δ₂ are predefined or preconfigured, and do not need to be sent to the SBS 112B each time in L1/DCI signaling. In these embodiments, the release time t₂ in FIG. 12 may be t₂=t₁+T_{R}.

In some other embodiments, the grace periods Δ₁ and Δ₂ may be customizable by the PBS 112A. In these embodiments, the grace periods Δ₁ and Δ₂ may be included in the spectrum-sharing notifications sent from the PBS 112A to the SBS 112B via DCI and/or RRC.

In some embodiments, instead of including the release duration T_{R} in the spectrum-sharing notifications sent from the PBS 112A to the SBS 112B, the PBS 112A may include the release time t₂ in the spectrum-sharing notifications sent to the SBS 112B.

In some embodiments, the release time t₂ is always at the end of the time period T. In these embodiments, the release duration T_{R} or the release time t₂ does not need to be included in the spectrum-sharing notifications sent from the PBS 112A to the SBS 112B.

Those skilled in the art will appreciate that, in above embodiments, some RBG-T blocks of usage type II in the releasable-block list may have already been reclaimed back to the PBS 112A before the PBS 112A sends a spectrum-sharing notification (that is, before the PBS 112A executing step 344 shown in FIG. 7). Similarly, some RBG-T blocks of usage type III in the reclaimable-block list may have already been released to the SBS 112B before the PBS 112A sends a spectrum-sharing notification. Thus, information of such RBG-T blocks may be excluded from the spectrum-sharing notification to be sent by the PBS 112A for further reducing the payload of the spectrum-sharing notification.

Thus, in some alternative embodiments, the PBS 112A may prepare a shortened releasable-block list including RBG-T blocks that has been recently changed to usage type II (that is, RBG-T now blocks reclaimed back for use by the PBS 112A) from usage type III (that is, RBG-T blocks previously used by the SBS 112B) after the last notification sent from the PBS 112A to SBS 114A. The PBS 112A may also prepare a shortened reclaimable-block list including RBG-T blocks that has been recently changed to usage type III (that is, released for use by the SBS 112B) from usage type II (that is, previously used by the PBS 112A) after the last notification sent from the PBS 112A to SBS 114A. The PBS 112A then sends to the SBS 112B the shortened releasable-block and/or reclaimable-block lists as the spectrum occupancy and usage information in a dynamic way using a procedure similar to the PBS-side spectrum-sharing procedure 340 shown in FIG. 7 with DCI signaling configuration.

As described above, the PBS 112A may send intermediate or dynamic spectrum-sharing notifications on shared spectrum usage changes via DCI signaling within the time period T in the comprehensive configuration via RRC. There are a few cases for information to be indicated by DCI signaling: (1) sending a Message R (being associated with the releasable-block list) within the time period T as shown in FIG. 12, (2) sending a Message C (being associated with the reclaimable-block list) within the time period T as shown in FIG. 13, (3) another comprehensive configuration (or notification) via RRC signaling at the beginning of the next time period T, as shown in FIGS. 12 and 13, (4) no comprehensive configuration change at the beginning of the next time period T, and thus no RRC is necessary. Towards this end, a two-stage DCI signaling may be used, where the first-stage DCI signaling may include information on at least one or more of above-described four cases to be further indicated with details by a second-stage DCI, as well as the time-frequency resources to transmit the second-stage DCI whose specific format and size can be predefined or (pre-) configured. For example, using two bits in a first-stage DCI field to indicate one of the above four cases,
setting the two bits to “00” to indicate that the second-stage DCI may include (1) a Message R that includes the releasable-block list;
setting the two bits to “01” to indicate that the second-stage DCI may include (2) a Message C that includes the reclaimable-block list;
setting the two bits to “10” to indicate (3) that new comprehensive configuration/notification via RRC is required, and thus the second-stage DCI may schedule time-frequency resources for PDSCH channel which carries RRC configuration message; and
setting the two bits to “11” to indicate (4) that no comprehensive configuration change at the beginning of the next time period T, thus no second-stage DCI is required and no RRC signaling is sent (in this case, at the beginning of the next period T, only one DCI (for example, first-stage DCI) with such an indication is sent to the SBS from the PBS).

Note that the first-stage DCI is transmitted in a PDCCH channel which is one of the search spaces defined/configured in CORESET (Control Resource Set). In some cases where both Message R and Message C are to be transmitted in a notification to the SBS, the first-stage DCI may also indicate this case such that the second-stage DCI signaling may include both the releasable-block and reclaimable-block lists; as two bits are not enough to indicate more than four cases, one more bit (thus a total of three bits) is required in the first-stage DCI to indicate these cases.

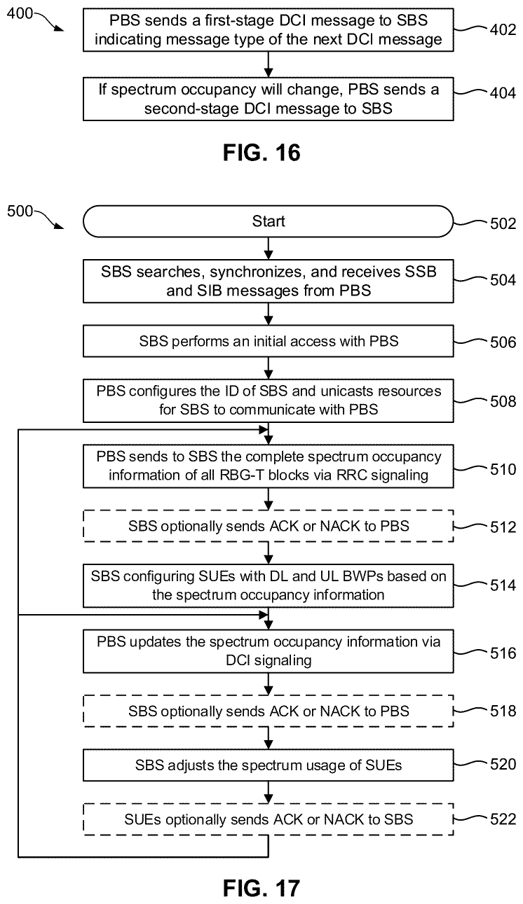

In some embodiments as shown in FIG. 16, the PBS 112A may executes a two-stage DCI signaling procedure 400 for sending the spectrum occupancy and usage information and an update to the SBS 112B. At step 402, the PBS 112A sends a first-stage DCI message to the SBS 112B comprising an indication for indicating the message type of the second-stage DCI message. The message type may include one-bit code indicating whether the second-stage DCI message comprises the Message R (being associated with releasable-block list) or Message C (being associated with the reclaimable-block list). It is optional that more than one bit indication on more situation including the second-stage DCI message comprising both Message R and Message C, for example.

The first-stage DCI message also optionally comprises one-bit indication for indicating if there is no change of spectrum occupancy or reconfiguration on the spectrum occupancy and usage information is required. In some embodiments, the first-stage DCI message may further comprise the size of the second-stage DCI message.

At step 404, if there is any change of spectrum occupancy, the PBS 112A sends a second-stage DCI message to the SBS 112B. The second-stage DCI message carries the simplified spectrum occupancy and usage information as described above. To indicate any use type for a RBG-T block in either releasable-block list or reclaimable-block list, for example, one-bit indication may be provided, where setting to “0” means no change while setting to “1” means convertible to the other usage type. Using Message R with a (RRC configured) releasable-block list as an example: after re-indexing of RRC configured resource blocks per usage type and if the releasable-block list has a size of 10 (II RBG-T blocks), then the second-stage DCI message may include a bit-map with 10 bits in DCI field(s) to indicate usage type status in the releasable-block list, that is, 10 bits in a DCI field may be set to sequence 0000100101 (corresponding RBG-T blocks indexed either from 0, 1, . . . , to 9 or from 9, 8, . . . , to 0), one for indication of corresponding RBF-T block in the list, where “0” means no usage type change (in this case, the corresponding RBG-T block is not released) and “1” means a usage type change (in this case, the corresponding RBG-T block is released for use by other node). Moreover, such as (dynamic) shared spectrum information update is sent on demand such as triggered due to the need of usage type change for one or more RBG-T blocks. Also, one timing parameter such as a releasing time period or reclaiming time period can be either predefined/RRC configured or (dynamically) indicated in a DCI signaling, for example, either in the first-stage DCI or the second-stage DCI, to indicate the shared spectrum update (the releasing RBG-T blocks or the reclaiming RBG-T blocks) to be valid for how long period of time, for example, valid for a while or valid until end of current time period T.

On the SBS side, the SBS 112B may blindly detect the first-stage DCI to obtain the information to receive the second-stage DCI.

If the SBS 112B fails to receive the first-stage or the second-stage DCI, the SBS 112 may send an NACK (negative acknowledgement) to the PBS 112A for re-sending. If the SBS 112B successfully receives the first-stage and second-stage DCIs, the SBS 112B may or may not send an ACK (acknowledgement) to the PBS 112A depending on the implementation. However, as those skilled in the art will appreciate, the SBS 112B sending ACK or NACK to acknowledge the signaling from the PBS 112A may facilitate avoidance of spectrum-usage conflict between the PBS 112A and the SBS 112B and mutual interference therebetween.

By using the two-stage DCI signaling procedure 400, the number of blind detections by the SBS 112B on PDCCH may be reduced. Moreover, by using the first-stage DCI message for indicating the message type of the second-stage DCI message and by including the size of the second-stage DCI message in the first-stage DCI message, the payload of the second-stage DCI message may be further reduced thereby giving rise to efficient use of DCI signaling.

In some other embodiments, the PBS 112A may not send to the SBS 112B the comprehensive spectrum-sharing notification comprising usage types of all RBG-T blocks at the beginning of every time period T. Rather, the PBS 112A may only send to the SBS 112B the comprehensive spectrum-sharing notification comprising usage types of all RBG-T blocks when needed.

In some embodiments, the PBS 112A may always send to the SBS 112B the comprehensive spectrum-sharing notification comprising usage types of all RBG-T blocks.

In some embodiments, the communication system 100 may comprise a plurality of secondary wireless communication networks 102B sharing the spectrum of the primary wireless communication network 102A. For example, in some embodiments, the communication system 100 may comprise a plurality of SBSs 112B. The PBS 112A may split a portion of the spectrum among different SBSs 112B and share it with the SBSs 112B using the spectrum-sharing methods described above.

For each SBS 112B, the PBS 112A may use usage type II to indicate the RBG-T blocks for use by the PBS 112A or other SBSs and releasable for use by this SBS 112B, and use usage type III to indicate the RBG-T blocks for use by this SBS 112B and reclaimable for use by the PBS 112A or other SBSs. Therefore, the RBG-T blocks to be used by other SBSs appear to this SBS 112B as if they are reserved for use by the PBS 112A, such that the spectrum occupancy and usage information of other SBSs is transparent to this SBS 112B.

In some embodiments, the communication system 100 may comprise a plurality of primary wireless communication networks 102A for sharing spectrums thereof with one or more secondary wireless communication networks 102B, wherein one of the primary wireless communication networks 102A may act as a control node to manage the shared spectrum usage among the primary and secondary wireless communication networks 102A and 102B.

In some other embodiments, the spectrum-sharing notifications sent to a SBS 112B may include usage type II for indicating the RBG-T blocks that are reclaimed back to use the PBS 112A, usage type III for indicating the RBG-T blocks that are released to use by the SBS 112B, and another usage type (for example, usage type V) for indicating the RBG-T blocks that are released to use by other SBSs.

In some embodiments, the PBS 112A may send the spectrum-sharing notifications to each SBS 112B separately (that is, in a unicast manner). In some other embodiments, the PBS 112A may broadcast the spectrum-sharing notifications to all SBSs 112B. In yet some other embodiments, the SBSs 112B may be grouped into a plurality of SBS groups each having a unique group ID. The PBS 112A may group-cast the spectrum-sharing notifications to each SBS group using the group ID thereof.

For example, in some embodiments, the PBS 112A may use the synchronization signal block (SSB) and system information blocks (SIBs) to broadcast the spectrum-sharing notifications to a plurality of SBSs 112B. In these embodiments, the PBS 112A may add an indication on spectrum usage into the master system information block (MIB) or SIB(s), wherein time-frequency resources may be configured for the SBSs 112B to monitor control information occasions and receive spectrum-sharing notifications, where initial or common resources/CORESET are configured. In these embodiments, No occupancy info update may also be indicated in the (first-stage) DCI. Alternatively, predefined resources such as fixed symbol and RBs may be used.

FIG. 17 is a flowchart showing a spectrum-sharing procedure 500 performed by the PBS 112A, the SBS 112B, and the SUEs 114B, according to some embodiments of this disclosure.

The procedure starts when the SBS 112B tries to join the primary wireless communication network 102A (step 502). At step 504, the SBS 112B searches, synchronizes, and receives the SSB and SIB messages from the PBS 112A. Then, the SBS 112B performs an initial access procedure with the PBS 112A including a random access channel (RACH) procedure, SBS capability reporting, registration, authentication, and authorization (step 506). The PBS 112A assigns or otherwise configures the ID of the SBS 112B and the unicasting resources for the SBS 112B to communicate with the PBS 112A including CORESET and PDCCH monitoring occasions by the SBS 112B (step 508).

At step 510, the PBS 112A sends the complete spectrum occupancy and usage information of all RBG-T blocks of a CC channel via RRC signaling as described above (that is, a major spectrum-sharing notification). Optionally at step 512, the SBS 112B may send to the PBS 112A an ACK if the SBS 112B successfully receives the complete spectrum occupancy and usage information, or an NACK if the SBS 112B fails to receive the complete spectrum occupancy and usage information.

At step 514, the SBS 112B configures the SUEs 114B thereof with DL and UL BWPs based on the spectrum occupancy and usage information received from the PBS 112A as described.

The primary and secondary wireless communication networks 102A and 102B thus operate on shared spectrum.

At step 516, the PBS 112A may send an intermediate spectrum-sharing notification via DCI signaling as described above. Optionally at step 518, the SBS 112B may send to the PBS 112A an ACK if the SBS 112B successfully receives the intermediate spectrum-sharing notification, or an NACK if the SBS 112B fails to receive the intermediate spectrum-sharing notification.

At step 520, the SBS 112B adjusts the spectrum usage of SUEs 114B as described above, such as broadcasting, group-casting, and/or unicasting the unavailable RBG-T blocks 302 of type II to the SUEs 114B. Optionally at step 522, each SUE 114B may send an ACK to the SBS 112B if the SUE 114B successfully receives the intermediate spectrum-sharing notification, or an NACK if the SUE 114B fails to receive the broadcast or group-cast from the SBS 112B.

The procedure 500 then goes to step 510 if a major spectrum-sharing notification is needed or step 516 if an intermediate spectrum-sharing notification is needed.

In above embodiments, the comprehensive spectrum occupancy and usage information of RBG-T blocks 302 is sent to the SBS 112B via RRC signaling. In some alternative embodiments, the comprehensive spectrum occupancy and usage information may be sent to the SBS 112B via DCI signaling if the size of the spectrum occupancy and usage information of RBG-T blocks 302 is suitable for sending via the DCI signaling. Alternatively, the spectrum occupancy and usage information of RBG-T blocks 302 is sent to the SBS 112B via a combination of RRC signaling and L1 (for example, DCI) signaling.

In above embodiments, four usage types are used. In other embodiments, the usage types of the RBG-T blocks may not be limited to the four types described above, and the communication system 100 may define two, three, four, or more usage types as needed. In other embodiments, the PBS notification on the shared spectrum occupancy may not include all the shared spectrum channels or all RBG-T blocks in a channel bandwidth of a frequency band; for example, the PBS notification to a SBS on the shared spectrum occupancy may include one or more usage types of the shared spectrum channel indices or RBG-T blocks from all possible shared spectrum types or (for example, four) RBG-T block types, and it is possible that the information on Type III only or Type II & IV shared spectrum/RBG-T blocks may be included in the notification from the PBS to the SBS.

In above embodiments where four usage types are used, the communication system 100 use a two-bit code to encode each of the four usage types. In some other embodiments, the communication system 100 does not encode types I and IV, and uses a one-bit code to encode the changeable types II and III (for example, “0” representing type II and “1” representing type III) for reducing the sizes of the releasable-block list and the reclaimable-block list.

The spectrum-sharing methods disclosed herein provide several advantage over for example, the conventional spectrum-sensing based methods.

As those skilled in the art understand, the conventional spectrum-sensing based methods such as those used in IEEE 802.22 or WI-FI are not very reliable and may lead to higher collision between signals of the PBS 112A and the SBS 112B. Moreover, due to the fact that the spectrum usage in the PBS 112A is generally dynamic over time, the time period from the time of detection of vacant channels or RBGs in in the PBS 112A (for example, by SUEs 114B) using spectrum-sensing to the time of the SBS 112B scheduling traffic to the SUEs 114B may often be too long such that the detected vacant channels or RBGs of the PBS 112A may not be vacant any more.

Unlike the conventional spectrum-sensing based methods, the spectrum-sharing methods disclosed herein enables the PBS 112A to notify the SBS 112B the spectrum occupancy and usage information in a timely manner over wireless backhauling via PBS access link for adapting to the dynamic nature of spectrum occupancy and sharing the spectrum in a fast and reliable manner.

### D. Acronym Key

BS: Base Station
BWP: Bandwidth part
CA: Carrier Aggregation
CC: Component Carrier
CG: Cell Group
CSI: Channel state information
CSI-RS: Channel state information Reference Signal
DC: Dual Connectivity
DCI: Downlink control information
DL: Downlink
DL-SCH: Downlink shared channel
EN-DC: E-UTRA NR dual connectivity with MCG using E-UTRA and SCG using NR
gNB: Next generation (or 5G) base station
HARQ-ACK: Hybrid automatic repeat request acknowledgement
LTE: Long-Term Evolution
MAC-CE: Medium Access Control-Control Element
MCG: Master cell group
MCS: Modulation and coding scheme
MOCN: Multi Operator Core Network
MORAN: Multi-Operator Radio Access Network
NR: New Radio
PBCH: Physical broadcast channel
PCell: Primary cell
PDCCH: Physical downlink control channel
PDSCH: Physical downlink shared channel
PRACH: Physical Random Access Channel
PRG: Physical resource block group
PSCell: Primary SCG Cell
PSS: Primary synchronization signal
PUCCH: Physical uplink control channel
PUSCH: Physical uplink shared channel
RACH: Random access channel
RAPID: Random access preamble identity
RB: Resource block
RE: Resource element
RMSI: Remaining system information
RRC: Radio Resource Control
RRM: Radio resource management
RS: Reference signal
RSRP: Reference signal received power
SCell: Secondary Cell
SCG: Secondary cell group
SFN: System frame number
SL: Sidelink
SPS: Semi-persistent scheduling
SR: Scheduling request
SRI: SRS resource indicator
SRS: Sounding reference signal
SSB: Synchronization Signal Block
SSS: Secondary synchronization signal
SUL: Supplement Uplink
TA: Timing advance
TAG: Timing advance group
TUE: target UE
UCI: Uplink control information
UE: User Equipment
UL: Uplink
UL-SCH: Uplink shared channel

Although embodiments have been described above with reference to the accompanying drawings, those of skill in the art will appreciate that variations and modifications may be made without departing from the scope thereof as defined by the appended claims.

1. A method for sharing a wireless spectrum, the wireless spectrum being divided into a plurality of time-frequency blocks, the method comprising:
sending usage information of at least a portion of the plurality of time-frequency blocks from a first node of a first radio access network (RAN) to a second node of a second RAN for the second node of the second RAN to use available time-frequency blocks of the plurality of time-frequency blocks for communication.

2. The method of claim 1, wherein said sending the usage information of the at least portion of the plurality of time-frequency blocks comprises:
sending from the first node to the second node the usage information of a first subset of the plurality of time-frequency blocks, a second subset of the plurality of time-frequency blocks, or a combination thereof.

3. The method of claim 2, wherein the first subset of the plurality of time-frequency blocks is a subset of the plurality of time-frequency blocks changed from releasably for use by a third node to reclaimably for use by the second node, and the second subset of the plurality of time-frequency blocks is a subset of the plurality of time-frequency blocks changed from reclaimably for use by the second node to releasably for use by the third node; or
wherein the first subset of the plurality of time-frequency blocks is a subset of the plurality of time-frequency blocks reclaimably for use by the second node as the available time-frequency blocks, and the second subset of the plurality of time-frequency blocks is a subset of the plurality of time-frequency blocks releasably for use by a third node.

4. The method of claim 2 further comprising:
assigning a usage type to each of the plurality of time-frequency blocks for indicating a usage status thereof;
wherein the usage type comprises:
a first usage type indicating that the time-frequency block associated therewith is reclaimably for use by the second node as the available time-frequency blocks, or
a second usage type indicating that the time-frequency block associated therewith is releasably for use by a third node.

5. An apparatus of a first radio access network (RAN) for sharing a wireless spectrum, the wireless spectrum being divided into a plurality of time-frequency blocks, the apparatus comprising:
a processing unit for:
sending usage information of at least a portion of the plurality of time-frequency blocks to a node of a second RAN for the node of the second RAN to use available time-frequency blocks of the plurality of time-frequency blocks for communication.

6. The apparatus of claim 5, wherein said sending the usage information of the at least portion of the plurality of time-frequency blocks comprises:
sending to the node of the second RAN the usage information of a first subset of the plurality of time-frequency blocks, a second subset of the plurality of time-frequency blocks, or a combination thereof.

7. The apparatus of claim 6, wherein the first subset of the plurality of time-frequency blocks is a subset of the plurality of time-frequency blocks changed from releasably for use by a node of a third RAN to reclaimably for use by the node of the second RAN, and the second subset of the plurality of time-frequency blocks is a subset of the plurality of time-frequency blocks changed from reclaimably for use by the node of the second RAN to releasably for use by the node of the third RAN
wherein the first subset of the plurality of time-frequency blocks is a subset of the plurality of time-frequency blocks reclaimably for use by the node of the second RAN as the available time-frequency blocks, and the second subset of the plurality of time-frequency blocks is a subset of the plurality of time-frequency blocks releasably for use by a node of a third RAN.

8. The apparatus of claim 6, wherein the processing unit is further configured for:
assigning a usage type to each of the plurality of time-frequency blocks for indicating a usage status thereof;
wherein the usage type comprises any one of:
a first usage type indicating that the time-frequency block associated therewith is reclaimably for use by the node of the second RAN as the available time-frequency blocks; and
a second usage type indicating that the time-frequency block associated therewith is releasably for use by a node of a third RAN.

9. The apparatus of claim 8, wherein the usage type further comprises any one of:
a third usage type indicating that the time-frequency block associated therewith is exclusively for use by the node of the second RAN; and
a fourth usage type indicating that the time-frequency block associated therewith is exclusively for use by a node of a third RAN.

10. The apparatus of claim 6, wherein the usage information of the at least portion of the plurality of time-frequency blocks comprises:
a first grace period for releasing the first subset of the plurality of time-frequency blocks for use by the node of the second RAN, or a second grace period for reclaiming the second subset of the plurality of time-frequency blocks for use by the node of the third RAN.

11. The apparatus of claim 5, wherein said sending the usage information of the at least portion of the plurality of time-frequency blocks comprises:
sending a first control message to the node of the second RAN, the first control message comprising a first indication for indicating the message type of a second control message; and
sending the second control message to the node of the second RAN, the second control message comprising the usage information of the at least portion of the plurality of time-frequency blocks.

12. The apparatus of claim 11, wherein the first message further comprises a second indication for indicating whether or not the usage information of the at least portion of the plurality of time-frequency blocks is changed; and
wherein said sending the second message to the node of the second RAN comprises:
sending the second message to the node of the second RAN if the usage information of the at least portion of the plurality of time-frequency blocks is changed.

13. An apparatus of a radio access network (RAN) for sharing a wireless spectrum, the wireless spectrum being divided into a plurality of time-frequency blocks, the apparatus comprising:
a processing unit for:
receiving usage information of at least a portion of the plurality of time-frequency blocks from a first node of a first RAN; and
using the usage information for communication using available time-frequency blocks of the plurality of time-frequency blocks.

14. The apparatus of claim 13, wherein said receiving the usage information of the at least portion of the plurality of time-frequency blocks comprises:
receiving from the first node the usage information of a first subset of the plurality of time-frequency blocks reclaimably for use by the apparatus as the available time-frequency blocks; or
receiving from the first node the usage information of a first subset of the plurality of time-frequency blocks reclaimably for use by the apparatus as the available time-frequency blocks, and a second subset of the plurality of time-frequency blocks releasably for use by a third node.

15. The apparatus of claim 13, wherein said receiving the usage information of the at least portion of the plurality of time-frequency blocks comprises:
receiving from the first node the usage information of:
a first subset of the plurality of time-frequency blocks changed from releasably for use by a third node to reclaimably for use by the second node; and
a second subset of the plurality of time-frequency blocks changed from reclaimably for use by the second node to releasably for use by the third node.

16. The apparatus of claim 14, wherein each of the plurality of time-frequency blocks is assigned with a usage type for indicating a usage status thereof;
wherein the usage type comprises any one of:
a first usage type indicating that the time-frequency block associated therewith is reclaimably for use by the second node; and
a second usage type indicating that the time-frequency block associated therewith is releasably for use by a third node.

17. The apparatus of claim 14, wherein the usage type further comprises any one of:
a third usage type indicating that the time-frequency block associated therewith is exclusively for use by the second node; and
a fourth usage type indicating that the time-frequency block associated therewith is exclusively for use by a third node.

18. The apparatus of claim 14, wherein the usage information of the at least portion of the plurality of time-frequency blocks comprises:
a first grace period for releasing the first subset of the plurality of time-frequency blocks for use by the second node, or a second grace period for reclaiming the second subset of the plurality of time-frequency blocks for use by the third node.

19. The apparatus of claim 13, wherein said receiving the usage information of the at least portion of the plurality of time-frequency blocks comprises:
receiving a first control message from the first node, the first message comprising a first indication for indicating the message type of a second control message; and
receiving the second control message from the first node, the second control message comprising the usage information of the at least portion of the plurality of time-frequency blocks.

20. The apparatus of claim 19, wherein the first message further comprises a second indication for indicating whether or not the usage information of the at least portion of the plurality of time-frequency blocks is changed; and
wherein said receiving the second message from the first node to the second node comprises:
receiving the second message from the first node if the second indication indicates that the usage information of the at least portion of the plurality of time-frequency blocks is changed.
